(19) United States
(12) Patent Application Publication
(10) Pub. No.: US 2008/0136256 A1
(43) Pub. Date: Jun. 12, 2008

(54) NETWORK DEVICES WITH SOLID STATE TRANSFORMER AND ELECTRONIC LOAD CIRCUIT TO PROVIDE TERMINATION OF OPEN-DRAIN TRANSMIT DRIVERS OF A PHYSICAL LAYER MODULE

(76) Inventor: Amit Gattani, Roseville, CA (US)

Correspondence Address: Mary Jo Bertani;KOESTNER BERTANI LLP, 18662 MacArthur Blvd., Irvine, CA, 92612, US

(21) Appl. No.: 11/609,308

(22) Filed: Dec. 11, 2006

(51) Int. Cl. H04B 3/54

(52) U.S. Cl. 307/2

(57) ABSTRACT

Embodiments disclosed herein provide a network device including an electronic load circuit coupled in parallel between a non-magnetic transformer and a physical layer (PHY) module. Data signals are received via a network connector, and the electronic load circuit is operable to provide DC termination of open-drain (DC common-mode control and current sourcing to) transmit drivers of a physical (PHY) layer module. A common-mode suppression (CMS) circuit can be coupled to positive and negative input signals to the PHY layer module. The CMS circuit is operable to block common-mode noise currents while passing differential mode data signal currents bi-directionally between the network connector and the PHY layer module.

### CROSS REFERENCE TO RELATED APPLICATIONS

This application claims the benefit of priority to and incorporates herein by reference in its entirety for all purposes, U.S. patent application Ser. No. 11/279,322 entitled “NETWORK DEVICES FOR SEPARATING POWER AND DATA SIGNALS,” by Philip John Crawley filed on Apr. 11, 2006.

### BACKGROUND

Many networks such as local and wide area networks (LAN/WAN) structures are used to carry and distribute data communication signals between devices. Various network elements include hubs, switches, routers, and bridges, peripheral devices, such as, but not limited to, printers, data servers, desktop personal computers (PCs), portable PCs and personal data assistants (PDAs) equipped with network interface cards. Devices that connect to the network structure use power to enable operation. Power of the devices may be supplied by either an internal or an external power supply such as batteries or an AC power via a connection to an electrical outlet.

Some network solutions can distribute power over the network in combination with data communications. Power distribution over a network consolidates power and data communications over a single network connection to reduce installation costs, ensures power to network elements in the event of a traditional power failure, and enables reduction in the number of power cables, AC to DC adapters, and/or AC power supplies which may create fire and physical hazards. Additionally, power distributed over a network such as an Ethernet network may function as an uninterruptible power supply (UPS) to components or devices that normally would be powered using a dedicated UPS.

Additionally, network appliances, for example voice-over-Internet-Protocol (VOIP) telephones and other devices, are increasingly deployed and consume power. When compared to traditional counterparts, network appliances use an additional power feed. One drawback of VOIP telephony is that in the event of a power failure the ability to contact emergency services via an independently powered telephone is removed. The ability to distribute power to network appliances or circuits enable network appliances such as a VOIP telephone to operate in a fashion similar to ordinary analog telephone networks currently in use.

Distribution of power over Ethernet (PoE) network connections is in part governed by the Institute of Electrical and Electronics Engineers (IEEE) Standard 802.3 and other relevant standards, which are incorporated herein by reference. However, power distribution schemes within a network environment typically employ cumbersome, real estate intensive, magnetic transformers. Additionally, power over Ethernet (PoE) specifications under the IEEE 802.3 standard are stringent and often limit allowable power.

Many limitations are associated with use of magnetic transformers. Transformer core saturation can limit current that can be sent to a power device, possibly further limiting communication channel performance. Cost and board space associated with the transformer comprise approximately 10 percent of printed circuit board (PCB) space within a modem switch. Additionally, failures associated with transformers often account for a significant number of field returns. Magnetic fields associated with the transformers can result in lower electromagnetic interference (EMI) performance.

However, magnetic transformers also perform several important functions such as supplying DC isolation and signal transfer in network systems. Thus, an improved approach to distributing power in a network environment may be sought that addresses limitations imposed by magnetic transformers while maintaining transformer benefits.

### SUMMARY

In some embodiments, a network device is disclosed that includes an electronic load circuit coupled in parallel between a non-magnetic transformer and a physical layer (PHY) module. Data signals are received via a network connector, and the electronic load circuit is operable to provide DC termination of open-drain (DC common-mode control and current sourcing to) transmit drivers of a physical (PHY) layer module.

In other embodiments, a network device includes an electronic load circuit and a common mode suppression (CMS) circuit coupled to positive and negative input signals to the PHY layer module. The CMS circuit is operable to block common-mode noise currents while passing differential mode data signal currents bi-directionally between the network connector and the PHY layer module.

### BRIEF DESCRIPTION OF THE DRAWINGS

Embodiments of the invention relating to both structure and method of operation may best be understood by referring to the following description and accompanying drawings:

FIGS. 1A and 1B show embodiments of client devices in which power is supplied separately to network attached client devices, and a power-over Ethernet (PoE) enabled LAN switch that supplies both data and power signals to the client devices;

FIG. 2 shows an embodiment of a network interface device including a network powered device (PD) interface and a network power supply equipment (PSE) interface, each implementing a non-magnetic transformer and choke circuit;

FIG. 3 is a diagram of an example of a configuration for a network interface device that includes non-magnetic transformers, electronic load circuits, and diode bridges to rectify power signals received from the transformers;

FIG. 4 is a diagram of an embodiment of an electronic load circuit and common mode suppression circuit;

FIG. 5 is a diagram of an embodiment of an electronic load circuit;

FIG. 6 is a diagram of another embodiment of an electronic load circuit;

FIG. 7 is a diagram of another embodiment of an electronic load circuit;

FIG. 8 is a diagram of an alternate embodiment of a network interface device that includes autotransformers;

FIG. 9 is a diagram of an alternate embodiment of a network interface device;

FIG. 10 shows another embodiment of a network interface device for non-Power Over Ethernet applications;

### DETAILED DESCRIPTION

The IEEE 802.3 Ethernet Standard, which is incorporated herein by reference, addresses loop powering of remote Ethernet devices (802.3af). Power over Ethernet (PoE) standard and other similar standards support standardization of power delivery over Ethernet network cables to power remote client devices through the network connection. The side of link that supplies power is called Powered Supply Equipment (PSE). The side of link that receives power is the Powered device (PD). Other implementations may supply power to network attached devices over alternative networks such as, for example, Home Phoneline Networking alliance (HomePNA) local area networks and other similar networks. HomePNA uses existing telephone wires to share a single network connection within a home or building. In other examples, devices may support communication of network data signals over power lines.

Furthermore, conventional transformers create insertion loss and return loss as well as limit high frequency performance. Replacing a conventional transformer with non-magnetic transformer removes a major source of data signal degradation and helps enable high speed operation, for example, Gigabit and 10 Gigabit operation.

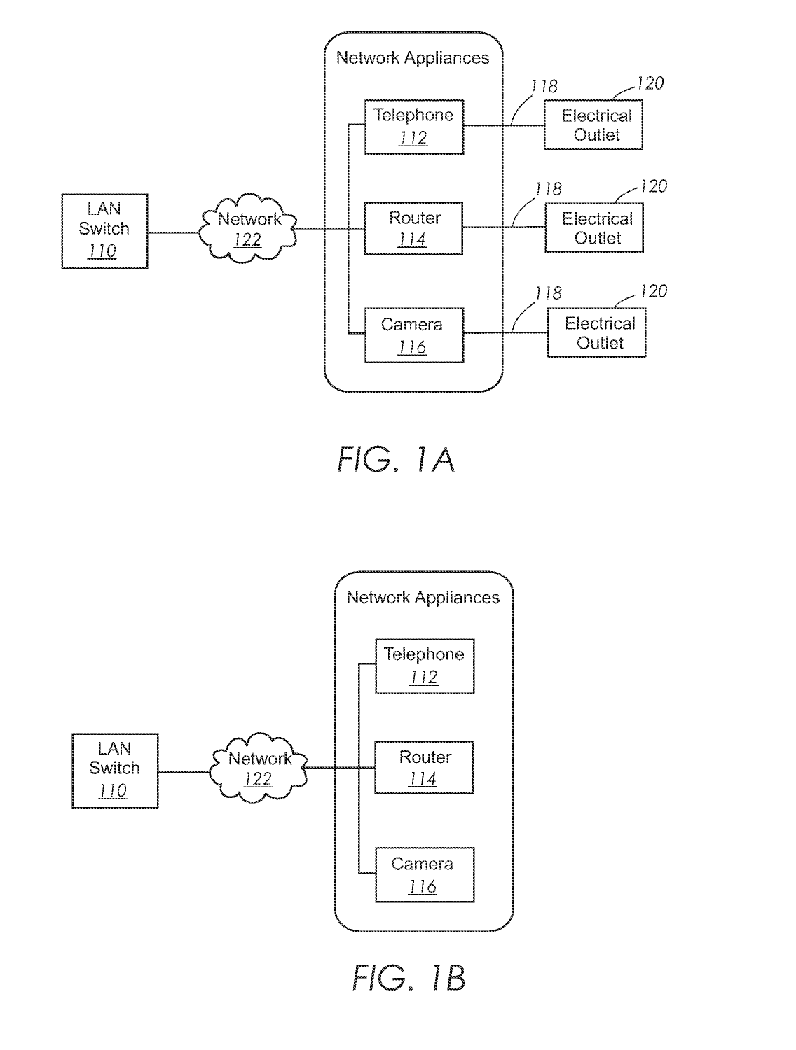

FIG. 1A is a schematic block diagram that illustrates a high level example embodiment of devices in which power is supplied separately to network attached client devices 112 through 116 that may benefit from receiving power and data via the network connection. The devices are serviced by a local area network (LAN) switch 110 for data. Individual client devices 112 through 116 have separate power connections 118 to electrical outlets 120. FIG. 1B is a schematic block diagram that depicts a high level example embodiment of devices wherein a switch 110 is a power supply equipment (PSE)-capable power-over Ethernet (PoE) enabled LAN switch that supplies both data and power signals to client devices 112 through 116. Network attached devices may include a Voice Over Internet Protocol (VOIP) telephone 112, access points, routers, gateways 114 and/or security cameras 116, as well as other network appliances. Network supplied power enables client devices 112 through 116 to eliminate power connections 118 to electrical outlets 120 as shown in FIG. 1A. Eliminating the second connection enables the network attached device to have greater reliability when attached to the network with reduced cost and facilitated deployment.

Although the description herein may focus and describe a system and method for coupling high bandwidth data signals and power distribution with particular detail to the IEEE 802.3af Ethernet standard, the concepts may be applied in non-Ethernet applications and non-IEEE 802.3af applications. Also, the concepts may be applied in subsequent standards that supersede or complement the IEEE 802.3af standard, such as HDSL (High bit-rate Digital Subscriber Line), T1/E1, cable modem, and other suitable technologies.

Typical conventional communication systems use transformers to perform common mode signal blocking, 1500 volt isolation, and AC coupling of a differential signature as well as residual lightning or electromagnetic shock protection. The functions are replaced by solid state or other similar circuits in accordance with embodiments of circuits and systems described herein whereby the circuit may couple directly to the line and provide high differential impedance and low common mode shunt impedance. High differential impedance enables separation of the physical layer (PHY) signal from the power signal. Low common mode shunt impedance facilitates elimination of magnetic chokes, thereby preventing EMI (Electro-Magnetic Interference) emissions and enabling EMI immunity. The local ground plane may float to eliminate a requirement for 1500 volt isolation. Additionally, voltage spike or lightning protection can be supplied to the network attached device through a combination of circuit techniques and lightning protection circuit, eliminating another function performed by transformers in traditional systems. The disclosed technology may be applied anywhere transformers are used and is not limited to Ethernet applications.

Specific embodiments of the circuits and systems disclosed herein may be applied to various powered network attached devices or Ethernet network appliances. Such appliances include, but are not limited to VoIP telephones, routers, printers, and other suitable devices.

In an Ethernet application, the IEEE 802.3af standard (PoE standard) enables delivery of power over Ethernet cables to remotely power devices. The portion of the connection that receives the power may be referred to as the powered device (PD). The side of the link that supplies power is called the power sourcing equipment (PSE).

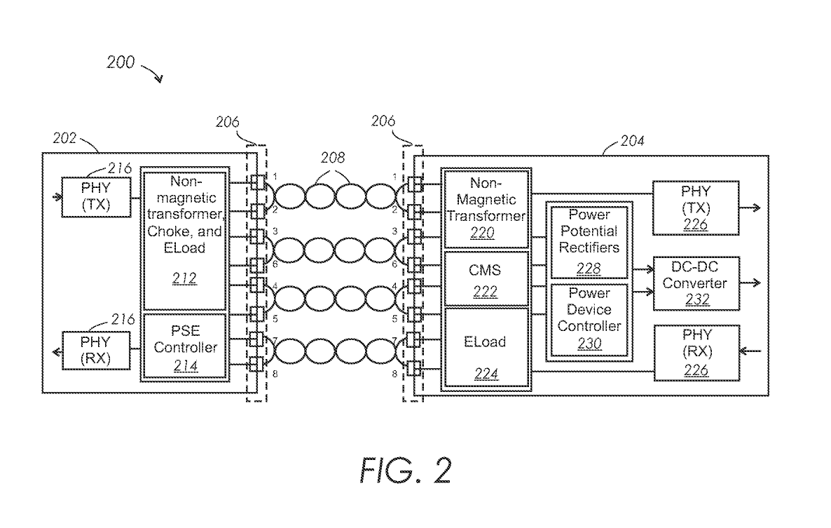

Referring to FIG. 2, a functional block diagram depicts an embodiment of a network device 200 including power source equipment (PSE) interface 202 coupled to powered device (PD) interface 204 via respective network connectors 206 and multiple twisted pair conductors 208 between connectors 206. Twisted pair conductors 208 can be, for example, twisted 22-26 gauge wire and connectors 206 can be RJ-45 connectors. Other suitable conductors and connectors can be used.

In the embodiment shown, PSE interface 202 includes non-magnetic transformer, choke, and Eload circuit 212 and power source equipment (PSE) controller 214 coupled between physical layer (PHY) layer module 216 and connector 206. non-magnetic transformer, choke, and Eload circuit 212 are implemented in integrated circuitry and replace the functionality of a magnetic transformer. Replacing magnetic transformers with solid state power feed circuit in the form of an integrated circuit or discreet component enables increased component density.

PD interface 204 can include non-magnetic transformer 220, common mode suppression (CMS) circuit 222, and electronic load (Eload) circuit 224 coupled between another connector 206 and PHY layer module 226. Power potential rectifiers 228 and power device controller 230 can be coupled between connector 206 and DC-DC converter 232.

Power potential rectifiers 228 rectify and pass a received power signal to ensure proper signal polarity is applied to DC-DC converter 230. The network device 200 typically sources power through lines 3, 4, 5, and 6 of the network connectors 206, however, other lines can be used. Power potential rectifiers 228 may be a diode bridge or other rectifying component or device. The circuits may be discrete components or an integrated circuit. Any one of a subset of the twisted pair conductors 208 can forward bias to deliver current, and the power potential rectifiers 228 can forward bias a return current path via a remaining conductor of the subset.

Power device controller 230 may be used to control power supply to network attached devices. The power signals are supplied by power potential rectifiers 228 to converter 232. Typically the power signal received does not exceed 57 volts SELV (Safety Extra Low Voltage). Typical voltage in an Ethernet application is 48-volt power. Converter 232 may then further transform the power to provide 1.8 to 12 volts, or other voltages specified by many Ethernet network attached devices, such as wireless access point circuitry or IP telephony circuitry.

If the PD interface 204 is used in an Ethernet network, may support the 10/100/1000 Mbps data rate and other future data networks such as a 10000 Mbps Ethernet network as well as other Ethernet data protocols that may arise. An Ethernet PHY layer module 226 may additionally couple to an Ethernet media access controller (MAC) (not shown). The PHY layer module 226 and Ethernet MAC when coupled can implement the hardware layers of an Ethernet protocol stack. The architecture may also be applied to other networks and protocols. If a power signal is not received but a traditional, non-power Ethernet signal is received at connector 206, the PD interface 204 still passes the data signal to the PHY layer module 226.

PSE interface 202 and PD interface 204 may be applied to an Ethernet application or other network-based applications such as, but not limited to, a vehicle-based network such as those found in an automobile, aircraft, mass transit system, or other like vehicle. Examples of specific vehicle-based networks may include a local interconnect network (LIN), a controller area network (CAN), or a flex ray network. All may be applied specifically to automotive and aircraft networks for the distribution of power and data to various monitoring circuits or for the distribution and powering of entertainment devices, such as entertainment systems, video and audio entertainment systems often found in today's transportation. Other networks may include a high speed data network, low speed data network, time-triggered communication on CAN (TTCAN) network, a J1939-compliant network, ISO11898-compliant network, an ISO11519-2-compliant network, as well as other similar networks. Other embodiments may supply power to network attached devices over alternative networks such as but not limited to a HomePNA local area network and other similar networks. HomePNA uses existing telephone wires to share a single network connection within a home or building. Alternatively, embodiments may be applied where network data signals are provided over power lines.

In some embodiments, non-magnetic transformer, choke, and Eload circuit 212, PHY layer modules 216, 226, PSE controller 214, non-magnetic CMS circuit 222, rectifiers 228, PD controller 230, and converter 232 may be implemented in integrated circuits rather than discrete components at the printed circuit board level. The circuits may be implemented in any appropriate process, for example, power components may be implemented using a high voltage silicon on insulator process whereas other components can be implemented using a 0.18 or 0.13 micron process or any suitable process.

Network device 200 may implement functions including IEEE 802.3.af signaling and load compliance, local unregulated supply generation with over current protection, and signal transfer between the lines 208 and integrated Ethernet PHY layer modules 216, 226. Since devices are directly connected to the line 208, the device 200 may be implemented to withstand a secondary voltage surge.

Non-magnetic transformer, choke, and Eload circuit 212 may take the form of a single or multiple port switch to supply power to single or multiple devices attached to the network. Power sourcing equipment interface 202 may be operable to receive power and data signals and combine to communicate power signals which are then distributed via an attached network. If power sourcing equipment interface 202 is included in a gateway or router computer, a high-speed uplink couples to a network such as an Ethernet network or other network. The data signal is relayed via network PHY 216 and supplied to non-magnetic transformer, choke, and Eload circuit 212. PSE interface 202 may be attached to an AC power supply or other internal or external power supply to provide a power signal to be distributed to network-attached devices that couple to connector 206.

Power sourcing equipment (PSE) controller circuit 214 within or coupled to non-magnetic transformer, choke, and Eload circuit 212 may determine, in accordance with IEEE standard 802.3af or other suitable standard, whether a network-attached device is operable to receive power via PD interface 204. When determined that a compliant powered device (PD) is attached to the network, PSE controller circuit 214 may supply power from power supply to non-magnetic transformer, choke, and Eload circuit 212, which is sent to the downstream network-attached device through network connectors 206, which in the case of the Ethernet network may be an RJ45 receptacle and cable.

IEEE 802.3af Standard is to fully comply with existing non-line powered Ethernet network systems. Accordingly, PSE controller 214 can detect via a well-defined procedure whether the attached devices are PoE compliant and provide sufficient power to the attached devices. In some implementations, the maximum allowed voltage is 57 Volts for compliance with SELV (Safety Extra Low Voltage) limits.

For backward compatibility with non-powered systems, PSE interface 202 can apply very low level power initially and higher power after confirming that a PoE device is present. For example, PSE controller 214 can apply a voltage between 14.5 Volts and 20.5 Volts during a classification phase to measure the current and determine the power class of a device. In some embodiments, the current signature is applied for voltages above 12.5 Volts and below 23 Volts. A current signature range can be used, for example, 0-44 milliamperes.

A maintain power signature can be applied in the PoE signature block. For example, a minimum of 10 mA and a maximum of 23.5 kilo-ohms may be applied for the PSE interface 202 to continue to feed power. The maximum current allowed is limited by the power class of the device, with class 0-3 typically being defined. For class 0, 12.95 Watts is the maximum power dissipation allowed and 400 milliamperes is the maximum peak current. Once activated, the PoE will shut down if the applied voltage falls below 30V and disconnect from the line 208.

PSE interface 202 in normal power mode provide a differential open circuit at the Ethernet signal frequencies and a differential short at lower frequencies. Non-magnetic transformer, choke, and Eload circuit 212 can present the capacitive and power management load at frequencies determined by PSE controller circuit 214.

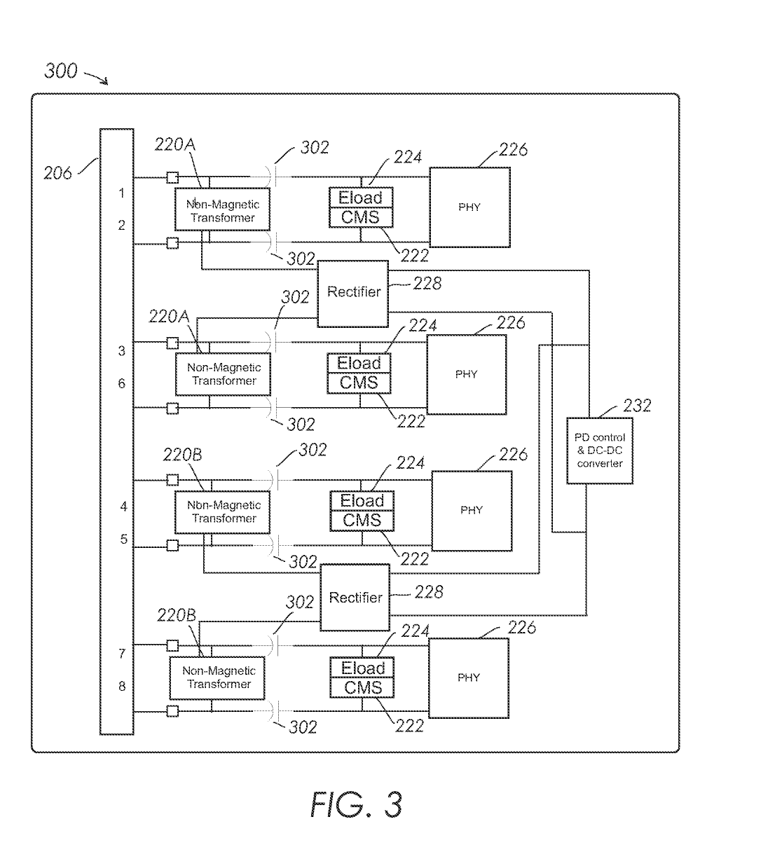

Referring to FIG. 3, a schematic circuit diagram of an embodiment of powered device (PD) interface 300 is shown that is suitable for use as PD interface 204 in FIG. 2. PD interface 300 includes connector 206 coupled to non-magnetic transformer circuits 220A, 220B. Non-magnetic transformer circuit 220A is connected across line pairs 1 and 2, and 3 and 6. Non-magnetic transformer circuit 22B is connected across line pairs 4 and 5, and 7 and 8. Capacitors 302 are coupled between transformers 220A, 220B and PHY layer modules 226. CMS circuits 222 and electronic load (Eload) circuits 224 are coupled in parallel between respective non-magnetic transformer circuits 220A, 220B and PHY layer modules 226.

In most Ethernet systems, physical layer transceiver uses an open drain style output stage. The output stage relies on data transformer's center tap to set the DC common mode level and act as current source between the center tap power supply and the medium dependent interface (MDI) signals. The inductance of the transformer provides a short-circuit at DC, and higher differential impedance at higher frequencies that allows transmission of a local data signal to the line.

As described previously, transformers create a variety of data integrity impairments in the transmission system, such as return loss, common-to-differential mode conversion, etc., and have reliability and cost issues associated with them. In a transformer-less interface, such as PD interface 300, PHY output stage DC control and current sourcing functionality can be supported by an active Eload circuit 224. The active Eload circuit 224 can be integrated along with CMS circuit 222, PHY layer modules 226, and other circuits in PD interface 300 in the same integrated circuit package to reduce the number of components and required circuit board space, thereby reducing the cost of the communication system.

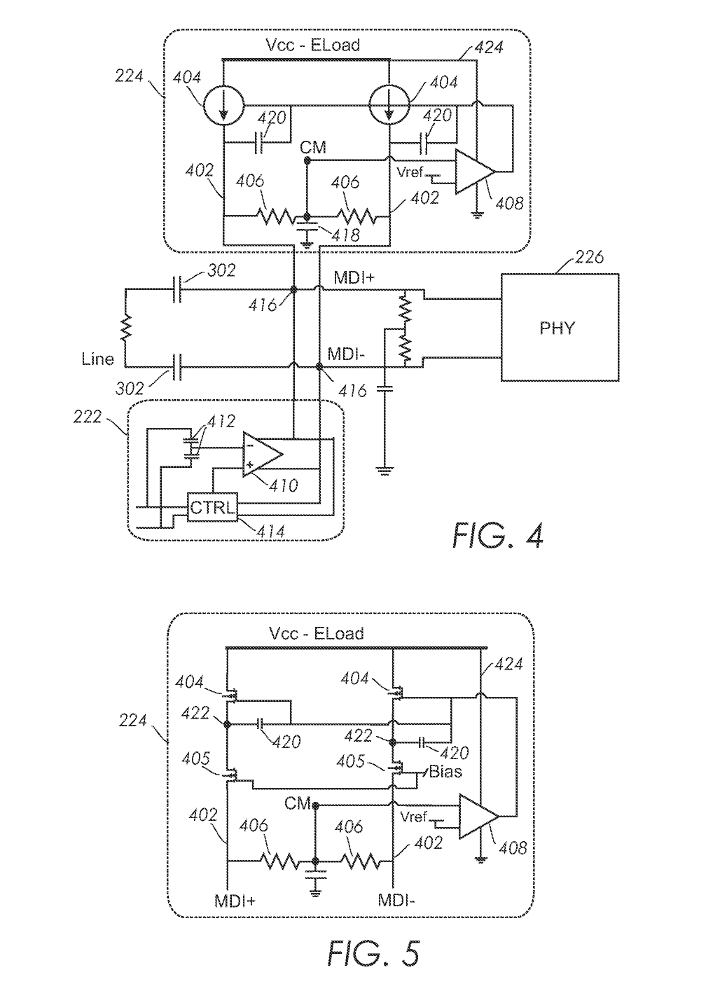

Eload circuit 224 provides common-mode (CM) output voltage control and a current source to the PHY layer module 226. FIG. 4 shows an embodiment of Eload circuit 224 that includes leads 402 coupled to respective positive and negative medium dependent interface (MDI) input signals to PHY layer module 226. Voltage source Vcc is coupled between leads 402, and current sources 404 are coupled inline with leads 402 between voltage source Vcc and MDI input signals to PHY layer module 226. Sense resistors 406 are coupled in series between positive and negative leads 402. Common mode (CM) lead is coupled between first and second sense resistors 406, and difference amplifier 408. The sense resistors 406 provide the function of summing up the signals from MDI positive and negative leads that cancels the differential component of the signal and retains only the common mode component of the signal on the CM lead. A reference voltage is supplied to another input of difference amplifier 408 and a signal representing the difference between the CM input signal and the reference voltage signal is output by difference amplifier 408 and supplied to current sources 404.

Eload circuit 224 further provides low-frequency or DC level Common-mode control on MDI nodes 416 and does not interfere with higher frequency differential or common-mode signals. Accordingly, loop bandwidth of a control loop formed by difference amplifier 408 and current sources 404 should typically be low. In one implementation, response and stability of the loop is controlled by a combination of filter capacitance 418 at the common mode (CM) node and compensation capacitors 420 coupled between the output of the difference amplifier 408 and the output of the current sources 404.

Capacitive loading on the MDI signals should generally be minimized to attain the desired high frequency signaling performance on MDI nodes 416. To help minimize capacitive loading, a cascade configuration for the current sources 404 can be used, as shown by another embodiment of Eload circuit 224 in FIG. 5. Eload circuit 224 uses an additional current source device 405, shown as a MOSFET device, between each current source device 404 and the respective MDI signal. The cascaded current source device 405 can typically be smaller in size than the current sources 404, hence reducing the capacitive loading on the MDI signals. In the configuration shown in FIG. 5, compensation capacitors 420 are coupled between output of difference amplifier 408 and nodes 422, where the nodes 422 are between current sources 404 and cascaded current source devices 405 to further minimize direct capacitive loading on the MDI signals.

Referring again to FIG. 4, the embodiment shown also includes an active common mode suppression (CMS) circuit 222 coupled to respective positive and negative MDI input signals to PHY layer module 226. Eload circuit 224 can sense and supply the current required by PHY layer module 226 and active CMS circuit 222. The common mode voltage level is controlled by active common-mode feedback to current sources 404 through differential amplifier 408, thereby providing a high differential mode impedance in the frequency band of interest for the signals to PHY layer module 226. Additionally, Eload circuit 224, active CMS circuit 222, and PHY layer module 226 can be integrated in the same integrated circuit process technology, thereby reducing fabrication cost and complexity.

Eload circuit 224 also provides the current source for the CMS circuit 222. Eload circuit 224 auto-senses the current drawn by the CMS circuit 222 and adjusts the current sources 404 automatically to source that current. In 10/100 Mbps Ethernet mode, data is transmitted only on data pair conductors 1-2 of the Ethernet connector 206, and received on data pair conductors 3-6. In 1000 Mpbs mode, data transmission is duplex and is transmitted on all 4 pairs. Hence Eload circuit 224 has to source current to PHY module 226 only on pair 1-2 in 10/100 MBps mode, while on all 4 data pairs in 1000 Mbps mode. Active feedback signal 424 output from difference amplifier 408 to current sources 404 in Eload circuit 224 enables current sources 404 to provide only the current required to the circuits connected to MDI signal lines while maintaining a steady state DC common mode voltage set by choice of reference voltage (Vref) for difference amplifier 408.

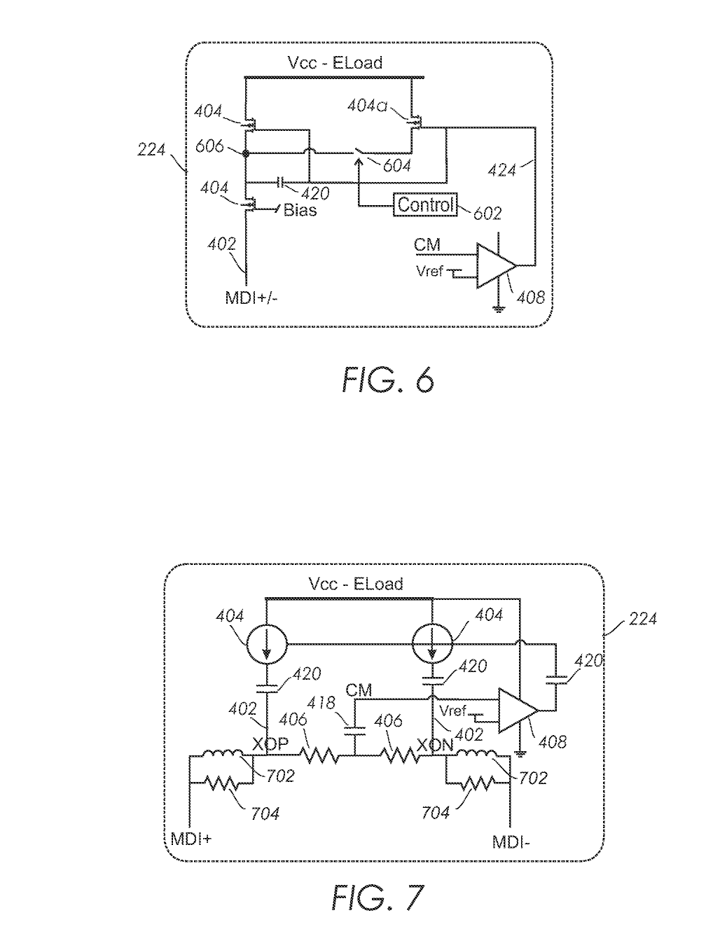

Referring to FIGS. 3 and 6, another embodiment of Eload circuit 224 is shown with a digitally programmable current source 404a. In some embodiments for programmable 10M/100M/1000 Meg Ethernet solutions, the current drawn by Ethernet PHY module 226 is different between 10M and 100M/1000 Meg modes. In one example solution, Ethernet PHY module 226 draws 50 mA current in 10 Meg mode and 20 mA current in 100M/1000M modes, per MDI signal line. To optimize the range of current supported by Eload circuit 224, a digitally programmable current source 404a can be implemented that is available only in desired modes, such as 10 Meg mode, that requires higher current. In the embodiment of Eload circuit 224 shown, a control module 602 is coupled to control a switch 604 at the output of current source 404a. Switch 604 can be turned on in desired modes, and off in other modes. The output of difference amplifier 408 is coupled to provide a feedback control signal 424 to programmable current source 404. The combination of digital programming in addition to feedback control signal 424 allows for optimum MOS device size needed to implement the current sources 404a, and thereby optimizing the cost of implementation. In the embodiment shown, switch 602 is coupled between the output of base current source 404a and a summing node 606 between cascaded current sources 404.

Referring again to FIG. 4, CMS circuit 222 senses and suppresses common-mode noise. In various implementations, common-mode noise may be sensed at MDI input signals or directly from line voltage. The sensed common-mode noise signals are passed to a common-mode suppression amplifier 410, which suppresses the common-mode noise on the MDI input signals to PHY layer 226.

A control device 414 can be coupled to the common-mode suppression amplifier 410 and PHY layer 226. Control device 414 may be adapted to control the common-mode suppression amplifier 410, enabling the PHY layer 226 to set a direct current (DC) value of common-mode voltage and suppress high-frequency common-mode signal components on MDI input signals. The control device 414 may be adapted to sample common-mode voltage at the Ethernet physical layer (PHY) output connections at regular intervals and adjust input to the common-mode suppression amplifier 410 to approximate the common-mode voltage. Capacitors 412 coupled to an input line to the common-mode suppression amplifier 410 may be implemented on a high voltage semiconductor die to facilitate blockage of high DC voltage. Control device 414 can also be coupled to the control loop amplifier 408 of Eload in a master-slave fashion where Eload common-mode control loop amplifier 408 acts as a master and control device 414 acts as a slave, providing overall DC control of the MDI signal nodes 416. In an alternate implementation, control device 414 and control loop amplifier 408 can be combined into one common-mode control loop amplifier.

Together the Eload circuit 224 and Common-Mode Suppression (CMS) circuit 222 provide DC common mode control of the MDI nodes 416 in a non-magnetic transformer based system solution. The circuits 222, 224 further source the power supply currents required by open-drain data driver of the Phy module 226. The CMS circuit 222 also provides Electro-Magnetic Interference control on the twisted pair lines.

Power supply for various embodiments of Eload circuit 224 can be provided from the DC-DC converter 232 (FIG. 2) via a line from PD controller 230 or powered locally. In some embodiments, the output of DC-DC converter 232 is controlled along with 10/100/1000 Mbps mode of the Eload circuit 224 to set the Vcc supply level to a level sufficient to allow differential data swing on the MDI signal lines (FIG. 4), thereby minimizing power consumption through Eload circuit 224.

Referring to FIG. 4, current sources 404 have to tolerate the differential signal swing seen at the MDI signals due to data transmission. That puts a challenging biasing constraint on the current sources 404 to keep them in saturation region while keeping the Vcc supply at a reasonable low level for low power consumption. In some embodiments, CMS circuit 222 can be modified to reduce the signal swing seen by the current sources 404.

Referring to FIG. 7, another embodiment of Eload circuit 224 includes resistors 406 forming a resistor divider between the MDI and CM signals. A DC bypass circuit including resistor 702 in parallel with inductor 704 is coupled to MDI lines in series with each resistor 406. The DC bypass circuit allows DC-common mode level of MDI± signals to be same as nodes XOP/XON (output from compensation capacitors 420), however the DC bypass circuit attenuates the Ethernet data signal swing seen by current sources 404 at XOP/XON nodes by a factor of R1/R2. In some embodiments, for example, choosing R1=200 Ohm and R2=10 KOhm, allows only 2% of the Ethernet signal swing to be seen by the current sources 404. This significantly reduces the headroom and Vcc requirement for the Eload circuit 224, resulting in very low power consumption.

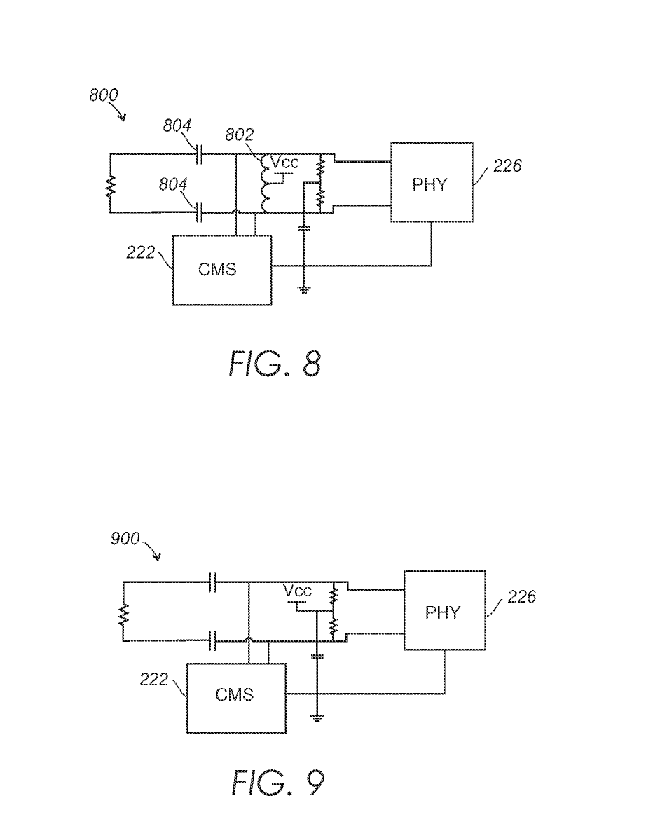

An alternate embodiment of a PD interface 800 that achieves the functionality of Eload circuit 224 is shown in FIG. 8 with CMS circuit 222 coupled to autotransformer 802. Autotransformer 802 is an electrical transformer with only one winding that replaces the winding of a magnetic transformer coupled to PHY module 226 in conventional systems. The winding has at least three electrical connection points called taps. The center tap can be connected to a power supply to feed current to circuits connected to the other 2 taps. Autotransformers have the same manufacturing, reliability, and data impairment issues as magnetic transformers. In addition, using autotransformer in conjunction with blocking capacitors 804 creates a second order high pass pole in path of network data transmission, compared to a first order high pass pole in traditional transformer based system. Such a second order pole will create higher loss of low frequency signal from data-transmission, creating issues such as baseline wander where under certain transmitted data patterns, the receiver can not recover the signal correctly due to loss of low frequency portion of the signal. PD interface 800 with autotransformer 802 avoids that problem by maintaining a first order high pass pole in the path of transmitted signal.

Another alternate way to achieve the functionality of Eload circuit 224 is to couple power supply Vcc to termination resistors 902 to, as shown by PD interface 900 in FIG. 9. Such an implementation has two major issues. First, there is no active control on the DC-common mode level at the MDI signals. The DC common mode level is determined by Vcc supply level and current drawn through resistors 902, which varies across many modes of PHY module 226 and the CMS circuit 222. Second, in addition to Ethernet differential swing, there is static voltage drop across the resistors 902 that is linearly dependent on current supplied by the resistors 902. In some modes of operation, for example 10 Mbps, the current drawn by the PHY module 226 and CMS circuit 222 can reach approximately 100 mA range, creating excessive voltage drop across the resistors. This will require a very high Vcc supply level and increase power consumption in the system.

PD interfaces 800 and 900 are feasible alternatives for some systems that can tolerate issues highlighted above, however a properly designed active Eload circuit 224, some embodiments of which have been described herein, can enable use of PD interfaces 204 with nonmagnetic transformers 220 (FIG. 2) with the widest range of transmission systems, including but not limited to, Power-over-Ethernet and traditional non-power over Ethernet systems.

Referring again to FIG. 3, non-magnetic transformers 220A, 220B receive input signals from the network connector 206. The first rectifier 228/non-magnetic transformer circuit 220A receives input power and data signals from across lines 1 and 2, and across lines 3 and 6 of the network connector 206. A second rectifier 228 /non-magnetic transformer circuit 220B receives input power and data signals from across lines 4 and 5, and across lines 7 and 8 of the network connector 206. For the power over Ethernet (PoE) to be IEEE 802.3af standard compliant, the PoE may be configured to accept power with various power feeding schemes and handle power polarity reversal. A rectifier, such as a diode bridge, a switching network, or other circuit, may be implemented to ensure power signals having an appropriate polarity are delivered to PD controller and DC-DC converter circuits 232.

The illustrative PD interface 300 may be implemented as part of a powered device (PD) that receives power sourced by power sourcing equipment (PSE), for example, on line pairs 1 and 2, and 3 and 6 on the network connector 206. One of the two pair of connections is at supply potential, for example VDD, and one is at ground potential. Power is applied to the two input terminals of rectifier circuits 228 at a high potential and a low potential but the potential applied to a particular input terminal is not important. Rectifier circuits 228 rectify the power signal so that no matter how power is connected, one output line is always at the VDD supply potential (VDD OUT) and another output line is at ground potential (GND OUT). Examples of rectifier circuits 228 that can be used include diode bridge rectifier circuits or MOSFET bridge rectifier circuits, among others.

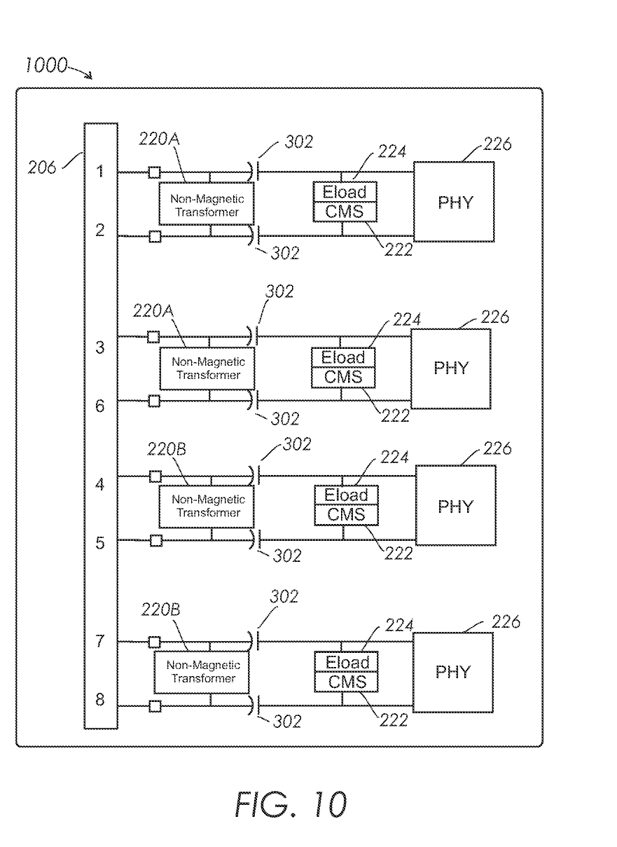

Referring to FIG. 10, a schematic circuit diagram of another embodiment of powered device (PD) interface 1000 is shown that is suitable for use as a PD interface for a non-Power over Ethernet application. PD interface 1000 includes connector 206 coupled to non-magnetic transformer circuits 220A, 220B. Non-magnetic transformer circuit 220A is connected across line pairs 1 and 2, and 3 and 6. Non-magnetic transformer circuit 22B is connected across line pairs 4 and 5, and 7 and 8. Capacitors 302 are coupled between transformers 220A, 220B and PHY layer modules 226. CMS circuits 222 and electronic load (Eload) circuits 224 are coupled in parallel between respective non-magnetic transformer circuits 220A, 220B and PHY layer modules 226.

By removing the traditional transformer, embodiments disclosed herein remove one of the major degrading circuits in the data signal path. The transformer creates insertion loss and return loss as well as limiting the high frequency performance. With the active boost approach, a transformer is no longer in the data signal path. Such features will help enable high speed data transfer in PoE networks, for example, Gigabit and 10 Gbit operation, as well as non-PoE networks.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a network interface are described including several optional implementations for particular portions. Any suitable combination or permutation of the disclosed designs may be implemented.

What is claimed is:

1. A network device comprising:
an electronic load circuit coupled in parallel between a line voltage source and a physical layer (PHY) module, wherein the line voltage source is received via a network connector, and the electronic load circuit is operable to provide current sourcing and DC termination of open-drain transmit drivers of a physical (PHY) layer module.

2. The network device according to claim 1 wherein:
the electronic load circuit includes leads coupled to respective positive and negative medium dependent interface (MDI) input signals to the PHY layer module.

3. The network device according to claim 2 wherein:
the electronic load circuit includes:
a voltage source Vcc coupled between the leads, and
current sources coupled inline with the leads between the voltage source Vcc and the MDI input signals to the PHY layer module.

4. The network device according to claim 3 wherein:
the electronic load circuit includes:
sense resistors coupled in series between the leads

5. The network device according to claim 4 wherein:
the electronic load circuit includes:
a common mode (CM) lead coupled between the sense resistors and a differential amplifier

6. The network device according to claim 5 wherein:
the electronic load circuit includes:
a reference voltage coupled to the differential amplifier, the differential amplifier being adapted to output a signal to the current sources, where the signal from the differential amplifier represents the difference between a signal from the CM lead and the reference voltage.

7. The network device according to claim 1 further comprising:
a common mode suppression (CMS) circuit coupled to positive and negative input signals to the PHY layer module.

8. The network device according to claim 7 wherein:
the CMS circuit is operable to block common-mode noise currents while passing differential data signal current bidirectionaly between the communication line and the PHY layer module.

9. The network device according to claim 7 wherein:
the Eload circuit senses and supplies current required by the PHY layer module and the CMS circuit.

10. The network device according to claim 1 wherein:
a common mode voltage level is controlled by active common-mode feedback in the Eload circuit through a differential amplifier to provide a high differential mode impedance in a frequency band of interest for signals to PHY layer module.

11. The network device according to claim 7 wherein:
the Eload circuit, CMS circuit, and PHY layer module are implemented in the same integrated circuit process technology.

12. The network device according to claim 1 further comprising:
a non-magnetic transformer coupled to transmit and receive signal pairs from a network connector and provide DC common-mode control and current sourcing to a physical layer (PHY) module; and
the Eload circuit and a CMS circuit are coupled in parallel between the transformer and the PHY layer module.

13. The network device according to claim 12 further comprising:
a capacitance at a common mode (CM) node of the electronic load circuit; and
compensation capacitors at the output of a difference amplifier and current sources.

14. The network device according to claim 1 further comprising:
a rectifying circuit adapted to conductively couple the network connector to an integrated circuit that rectifies and passes a power signal received from the network connector.

15. The network device according to claim 14 wherein:
the rectifying circuit regulates a received power and/or data signal to ensure proper signal polarity is applied to the integrated circuit.

16. The network device according to claim 14 wherein:
the network connector receives a plurality of twisted pair conductors; and
any one of a subset of the twisted pair conductors can forward bias to deliver current and the rectifying circuit forward biases a return current path via remaining conductors of the subset.

17. The network device according to claim 14 wherein the rectifying circuit includes a diode bridge.

18. The network device according to claim 6 wherein the rectifying circuit includes a transistor bridge integrated onto the integrated circuit, and transistors in the transistor bridge are selected from a group consisting of metal oxide semiconductor (MOS) transistors, bipolar junction transistors (BJT), junction field effect transistors (JFET), switchable devices, and impedance control devices.

19. A network device comprising:
an electronic load circuit coupled between a line voltage source and a physical layer (PHY) module, wherein the line voltage source is received via a network connector, and the electronic load circuit is operable to provide data signals to a physical (PHY) layer module, and the electronic load circuit includes:
a voltage source Vcc coupled between input leads to the PHY layer module,
current sources coupled inline with the input leads between the voltage source Vcc and the PHY layer module; and
a common mode suppression (CMS) circuit coupled to positive and negative input signals to the PHY layer module and operable to block common-mode noise currents while passing differential data signal current bidirectionaly on a communication line coupled to the PHY layer module

20. The network device according to claim 19 wherein:
the electronic load circuit further includes:
sense resistors coupled in series between the input leads

21. The network device according to claim 20 wherein:
the electronic load circuit further includes:
a common mode (CM) lead coupled between the sense resistors and a differential amplifier

22. The network device according to claim 21 wherein:
the electronic load circuit further includes:
a reference voltage coupled to the differential amplifier, the differential amplifier being adapted to output a signal to the current sources, where the signal from the differential amplifier represents the difference between a signal from the CM lead and the reference voltage.

23. The network device according to claim 19 wherein:
the Eload circuit senses and supplies current required by the PHY layer module and the CMS circuit.

24. The network device according to claim 19 further comprising:
a transformer coupled to receive input signals from a network connector and supply data signals to a physical layer (PHY) module; and
the Eload circuit and the CMS circuit are coupled in parallel between the transformer and the PHY layer module.

25. The network device according to claim 24 further comprising:
two or more current sources coupled in series to form a cascade configuration for the current sources.

26. The network device according to claim 19 further comprising:
a rectifying circuit adapted to conductively couple the network connector to an integrated circuit that rectifies and passes a power signal received from the network connector.

27. The network device according to claim 26 wherein:
the rectifying circuit regulates a received power and/or data signal to ensure proper signal polarity is applied to the integrated circuit.

28. The network device according to claim 19 wherein:
the network connector receives a plurality of twisted pair conductors; and
any one of a subset of the twisted pair conductors can forward bias to deliver current and the rectifying circuit forward biases a return current path via remaining conductors of the subset.

29. A network device comprising:
a first connector portion;
a non-magnetic transformer coupled to the first connector portion;
an electronic load circuit coupled between the non-magnetic transformer and a physical layer (PHY) module, wherein data signals are received via the first connector portion, and the electronic load circuit is operable to provide data signals to a physical (PHY) layer module.

30. The network device according to claim 29 wherein:
the electronic load circuit includes:
a voltage source Vcc coupled between input leads to the PHY layer module,
current sources coupled inline with the input leads between the voltage source Vcc and the PHY layer module.

31. The network device according to claim 29 further comprising:
a common mode suppression (CMS) circuit coupled to positive and negative input signals to the PHY layer module and operable to block common-mode noise currents while passing differential data signal current bidirectionaly on a communication line coupled to the PHY layer module.

32. The network device according to claim 29 wherein:
the electronic load circuit further includes:
sense resistors coupled in series between the input leads

33. The network device according to claim 32 wherein:
the electronic load circuit further includes:
a common mode (CM) lead coupled between the sense resistors and a differential amplifier

34. The network device according to claim 33 wherein:
the electronic load circuit further includes:
a reference voltage coupled to the differential amplifier, the differential amplifier being adapted to output a signal to the current sources, where the signal from the differential amplifier represents the difference between a signal from the CM lead and the reference voltage.

35. The network device according to claim 30 further comprising:
two or more current sources coupled in series to form a cascade configuration for the current sources.
